(19) United States
(12) Patent Application Publication
(10) Pub. No.: US 2012/0136978 A1
(43) Pub. Date: May 31, 2012

(54) RACK SERVER SYSTEM AND MANAGEMENT METHOD OF THE SAME

(75) Inventors: Kang-Zhen LOU, SHANGHAI (CN); Ting-Ting CHEN, SHANGHAI (CN); Xiao-Hua WANG, SHANGHAI (CN)

(73) Assignee: INVENTEC CORPORATION, TAIPEI CITY (TW)

(21) Appl. No.: 13/031,625

(22) Filed: Feb. 22, 2011

(30) Foreign Application Priority Data
Nov. 30, 2010 (CN) 201010575245.9

(51) Int. Cl. G06F 15/173

(52) U.S. Cl. 709/223

(57) ABSTRACT

A rack server system management method adapted in a rack server system is provided. The rack server system management method comprises the steps as follows. The first information of a plurality of servers in the rack server system and the second information of a plurality of fan modules in the rack server system are updated every predetermined time period by a document management unit. A rack management module retrieves the first and the second information through polling the document management unit. The rack management module retrieves temperature values of the servers from the first information and adjusts the speed of the fan module according to the second information. A rack server system is disclosed herein as well.

### RELATED APPLICATIONS

This application claims priority to China Application Serial Number 201010575245.9, filed Nov. 30, 2010, which is herein incorporated by reference.

### BACKGROUND

1. Field of Invention

The present invention relates to a server system, and more particularly to a rack server system and a management method of the same.

2. Description of Related Art

Internet is an important tool for information communication in modern life. In order to provide various network services, a server plays an important role in enabling a remote user to access information in the server through a network. In order to deal with massive data, many servers are centralized and packaged together. However, in such an arrangement manner, each server is still managed separately. For many servers centralized in the same rack, without a centralized control management mechanism, it is impossible to optimize the management thereof in an overall environment condition.

Therefore, how to design a new rack server system and a management method of the same to wholly control and manage the rack server system is still an urgent problem in the field.

### SUMMARY

Therefore, an aspect of the present invention provides a rack server system management method adapted in a rack server system. The rack server system management method includes the following steps. The first information of a plurality of servers in the rack server system and the second information of a plurality of fan modules in the rack server system are updated every predetermined time period by a document management unit. A rack management module retrieves the first and the second information through polling the document management unit. The rack management module retrieves temperature values of the servers from the first information and adjusts the speed of the fan module according to the second information.

According to an embodiment of the present invention, each server further includes a server baseboard management controller, so as to collect the temperature values of the servers for updating the first information. The first information further includes an Internet address which is allocated on the rack by the servers and a plurality of temperature sensors within the servers. The temperature sensors transfer the temperature values to the server baseboard management controllers of the servers.

According to another embodiment of the present invention, the rack server system further includes at least one fan control module which is coupled to the fan modules and the rack management module. The step of adjusting the speed of the fan modules by the rack management module further includes the following step. The rack management module transmits at least one control signal to adjust the speed of the fan modules according to the control signal by the fan control module.

According to a further embodiment of the present invention, the rack management module is a rack baseboard management controller.

According to yet another embodiment of the present invention, the rack server system further includes a display unit. After the rack management module retrieves the first information and the second information, the method further includes the following step. The rack management module displays the first information and the second information.

According to yet another embodiment of the present invention, the number of the rack management modules is two and the rack management modules are redundant to each other.

According to still another embodiment of the present invention, the first information and the second information are corresponding to each other and the second information is adjusted according to the first information.

Another aspect of the present invention provides a rack server system which includes a rack, a plurality of servers, a plurality of fan modules, a rack management module and a document management unit. The servers are disposed on the rack. The fan modules are disposed on the rack for dissipating heat from the servers. The rack management module is coupled to the fan modules and the servers. The document management unit has first information of the servers and second information of the fan modules. The first information and the second information are updated every predetermined time period by the document management unit. The rack management module retrieves the first information and the second information through polling the document management unit. The rack management module retrieves temperature values of the servers from the first information and adjusts the speed of the fan modules according to the second information.

According to an embodiment of the present invention, each server further includes a server baseboard management controller therein, so as to collect the temperature values of the servers for updating the first information. The first information further includes an Internet address which is allocated on the rack by the servers and a plurality of temperature sensors within the servers. The temperature sensors transfer the temperature values to the server baseboard management controllers of the servers.

According to another embodiment of the present invention, the rack server system further includes at least one fan control module coupled to the fan modules and the rack management module. The rack management module reads the second information and transmits at least one control signal. The fan control module adjusts the speed of the fan modules according to the control signal.

According to a further embodiment of the present invention, the rack management module is a rack baseboard management controller.

According to yet another embodiment of the present invention, the rack server system further includes a display unit for displaying the first information and the second information of the document management unit.

According to yet another embodiment of the present invention, the number of the rack management modules is two and the rack management modules are redundant to each other.

According to still another embodiment of the present invention, the first information and the second information are corresponding to each other and the second information is adjusted according to the first information.

Applying the present invention has the following advantages. The rack management module retrieves the first information of the servers and the second information of the fan modules through polling the document management unit periodically, so as to retrieve information of the overall rack server system, thereby achieving the effect of a centralized control to optimize the management efficiency.

It is to be understood that both the foregoing general description and the following detailed description are by examples, and are intended to provide further explanation of the invention as claimed.

### BRIEF DESCRIPTION OF THE DRAWINGS

In order to make the foregoing as well as other aspects, features, advantages, and embodiments of the present invention more apparent, the accompanying drawings are described as follows:

FIG. 1 is a schematic view of a rack server system according to an embodiment of the present invention;

FIG. 2 is a flow chart of a rack server system management method, according to an embodiment of the present invention;

FIG. 3 is a more detailed flow chart of a polling step of retrieving first information of a sensor of a server; and

FIG. 4 is a more detailed flow chart of a polling step of retrieving second information of fan modules.

### DETAILED DESCRIPTION

The aspect of the present invention is to provide a rack server system which includes a rack, a plurality of servers, a plurality of fan modules, a rack management module and a document management unit. The rack management module is coupled to the fan modules and the servers disposed on the rack. The rack management module retrieves first information and second information which are updated every predetermined time period in the document management unit through polling the document management unit. The rack management module retrieves temperature values of the servers from the first information and adjusts the speed of the fan modules according to the second information, thereby achieving the effect of a centralized control to optimize the management efficiency.

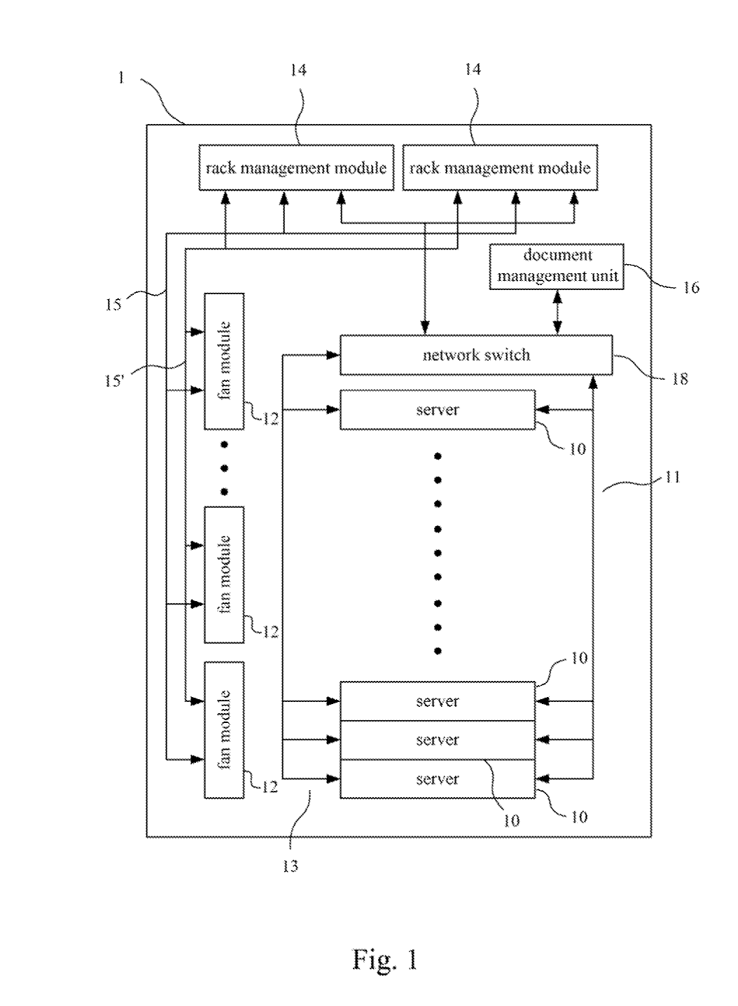

Referring to FIG. 1, FIG. 1 is a schematic view of a rack server system according to an embodiment of the present invention. The rack server system includes a rack 1, a plurality of servers 10, a plurality of fan modules 12, a rack management module 14 and a document management unit 16.

The servers 10 and the fan modules 12 are disposed and connected on the rack 1. In an embodiment, each server 10 is a main board and includes at least one sensor (not shown) formed thereon. The sensor is used to sense various environment conditions of the server 10, such as temperature, voltage and power consumption, so as to obtain sensed values. Each server 10 further includes a server baseboard management controller (not shown), so as to access and control the sensor.

Each of the fan modules 12 includes at least one fan (not shown) for dissipating heat from the server 10. In an embodiment, the fan module 12 includes the fan and a fan control module (not shown), and the fan control module controls the speed of the fan.

The rack server system further includes a rack management network 11, a work management network 13 and a serial control interface 15. The servers 10 are all connected with the rack management network 11 and the work management network 13, and are further connected with other devices through a network switch 18. The servers 10 can be connected with an external network through the work management network 13 and the network switch 18, so as to communicate information. The rack management module 14 can communicate with and manage each of the servers 10 and the document management unit 16 through the rack management network 11 and the network switch 18. In an embodiment, the rack management module 14 is a rack baseboard management controller, and the number of the rack management modules is two and the rack management modules are redundant to each other.

In addition, the rack management module 14 is connected with the fan modules 12 through the serial control interface 15. In an embodiment, the serial control interface can be an RS 485 interface. In other embodiments, the rack management module 14 can communicate with the fan modules 12 through an appropriate interface. In an embodiment, the number of the serial control interfaces 15 can be two and the serial control interfaces are redundant to each other, so that when one serial control interface cannot operate, the other serial control interface provides the communication between the rack management module 14 and the fan modules 12. The rack management module 14 is essentially connected with the fan control module in the fan modules 12, so as to transfer a control signal into the fan control module, and thus the fan control module controls the speed of the fan modules 12 according to the control signal.

Thus, through the rack management network 11 and the serial control interface 15 described above, the rack management module 14 can be coupled to the fan modules 12 and the servers 10.

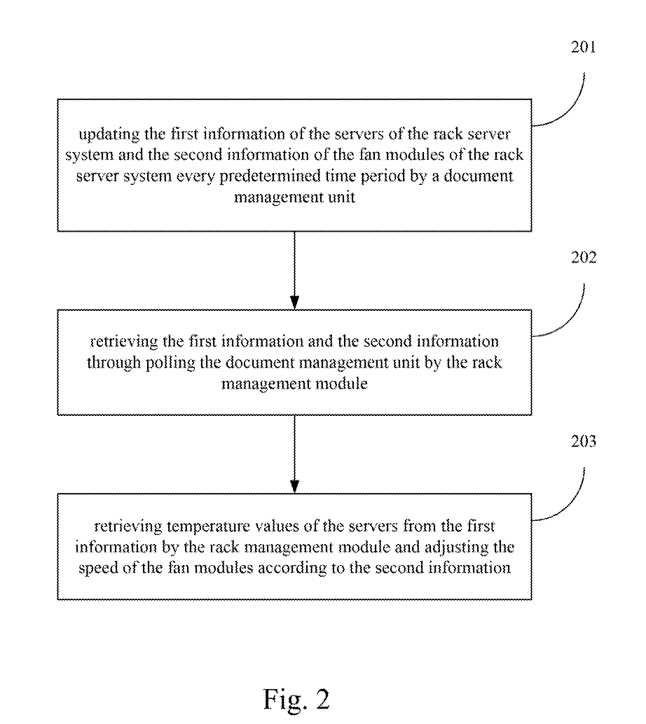

Referring to FIG. 2 at the same time, FIG. 2 is a flow chart of a rack server system management method according to an embodiment of the present invention. The rack server system management method can be adapted in the rack server system of FIG. 1. The rack server system management method includes the following steps (It should be appreciated that the sequence of the steps mentioned in this embodiment may be adjusted, or the steps may even be executed simultaneously or partially simultaneously as required unless specified otherwise).

In step 201, the first information of the servers 10 and the second information of the fan modules 12 are updated every predetermined time period by the document management unit 16. The first information and the second information may correspond to each other and the second information is adjusted according to the first information. In an embodiment, the first information includes an Internet address of the rack management network 11 allocated on the rack by the servers 10, temperature sensors within the servers 10 and temperature values sensed by the temperature sensors. The above sensors can transfer the temperature values to the server baseboard management controller of the servers 10 and the first information is updated by the document management unit 16. The second information includes the speed of the fans in the fan modules 12, and the speed of the fans is adjusted according to the temperature values. In an embodiment, the rack server system may further include a display unit for displaying the first information and the second information of the document management unit 16 for a user to make reference.

Then, in step 202, the rack management module 14 can retrieve the first information and the second information through polling the document management unit 16. The polling action can be performed by the rack management network 11. Therefore, the condition of the entire rack server system can be retrieved and updated every certain time period by the rack management module 14.

In step 203, the rack management module 14 retrieves the temperature values of the servers from the first information, and adjusts the speed of the fan modules in real time through the fan speed according to the second information. In an embodiment, after the rack management module 14 inquires a fan speed table (not shown) according to the first information and the second information, the rack management module can transfer the control signal to the fan control module, so as to further control the speed of the fans in the fan modules 12.

Therefore, through the above embodiments, the first information and the second information can be updated every certain time period by the document management unit 16, so that after the rack management module 14 retrieves the first information and the second information, the speed of the fan modules 16 can be adjusted according to the temperature condition of each server 10 and the operation condition of the fan modules 16.

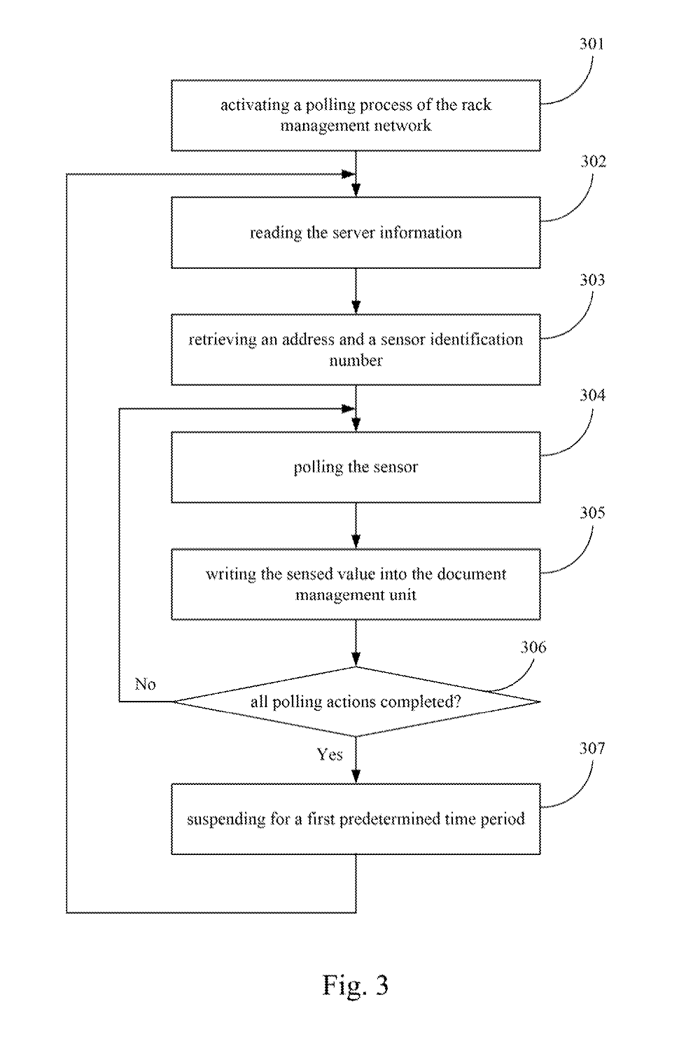

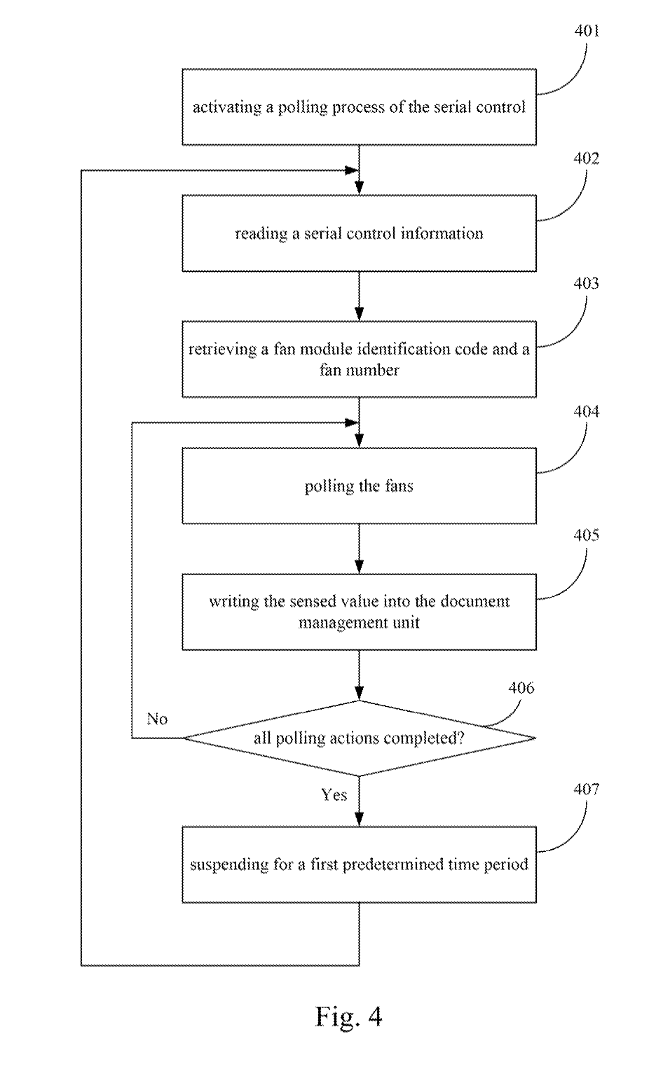

Referring to FIGS. 3 and 4, FIG. 3 is a more detailed flow chart of the polling step of retrieving the first information of the sensor of the servers 10 according to an embodiment, and FIG. 4 is a more detailed flow chart of the polling step of retrieving the second information of the fan modules 12. It should be noted that the polling processes of retrieving the first information and the second information can be two processes that are performed concurrently.

Refer to FIG. 3 first. In step 301, a polling process of the rack management network is activated. Then, in step 302, the server information is read, and in step 303, the Internet address and a sensor identification number of the rack management network 11 of each server 10 in the server information are retrieved. In step 304, the sensor of the server 10 is polled according to the Internet address and the sensor identification number. In step 305, the sensed value of the sensor is written into the document management unit 16, and in step 306, it is determined whether all polling actions of the servers 10 have been completed. If all polling actions have not been completed, the process returns to step 304 to continue polling the sensor of the server 10. If all polling actions have been completed, in step 307 the polling process of the rack management network is suspended for a first predetermined time period, and then the process returns to step 302 to read the server information and start a next polling again.

Refer to FIG. 4. In step 401, a polling process of the serial control is activated. Then, in step 402, the serial control information is read, and in step 403, a fan module identification code and a fan number of each fan module 12 in the serial control information are retrieved. In step 404, the fan module 12 is polled according to the fan module identification code and the fan number. In step 405, the speed value of the fan is written into the document management unit 16 by the rack management module 14. In step 406, it is determined whether the last field of the tabular serial control information has been reached, i.e. whether all polling actions have been completed. If all polling actions have not been completed, the process returns to step 404 to continue polling the fans of the fan modules 12. If all polling actions have been completed, in step 407 the polling process of the serial control is suspended for a second predetermined time period, and then the process returns to step 402 to read the serial control information and start the next polling again.

Therefore, through the above embodiments, the overall environment condition of the rack server system can be retrieved by the rack management module 14, so as to adjust and control the overall condition of the rack server system.

Although the present invention has been disclosed with reference to the embodiments above, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A rack server system management method adapted in a rack server system, comprising the steps of:
updating the first information of a plurality of servers of the rack server system and the second information of a plurality of fan modules of the rack server system every predetermined time period by a document management unit;
retrieving the first information and the second information through polling the document management unit by a rack management module; and
retrieving temperature values of the servers from the first information by the rack management module, so as to adjust the speed of the fan modules according to the second information.

2. The rack server system management method of claim 1, wherein each of the servers further comprises a server baseboard management controller for collecting the temperature value of the server to update the first information.

3. The rack server system management method of claim 1, wherein the first information further comprises an Internet address which is allocated on the rack by the servers and a plurality of temperature sensors within the servers, and the temperature sensors transfer the temperature values to a server baseboard management controller of the servers.

4. The rack server system management method of claim 1, wherein the rack server system further comprises at least one fan control module which is coupled to the fan modules and the rack management module, and the step of adjusting the speed of the fan modules by the rack management module further comprises:
transmitting at least one control signal by the rack management module, so as to adjust the speed of the fan modules according to the control signal by the fan control module.

5. The rack server system management method of claim 1, wherein the rack management module is a rack baseboard management controller.

6. The rack server system management method of claim 1, wherein the rack server system further comprises a display unit, and after retrieving the first information and the second information by the rack management module, the method further comprises:
displaying the first information and the second information by the rack management module.

7. The rack server system management method of claim 1, wherein the number of the rack management modules is two and the rack management modules are redundant to each other.

8. The rack server system management method of claim 1, wherein the first information and the second information are corresponding to each other and the second information is adjusted according to the first information.

9. A rack server system, comprising:
a rack;
a plurality of servers disposed on the rack;
a plurality of fan modules disposed on the rack for dissipating heat from the servers;
a rack management module coupled to the fan modules and the servers; and
a document management unit having first information of the servers and second information of the fan modules, wherein the first information and the second information are updated every predetermined time period by the document management unit, and the rack management module retrieves the first information and the second information through polling the document management unit and retrieves temperature values of the servers from the first information, and adjusts the speed of the fan modules according to the second information.

10. The rack server system of claim 9, wherein each of the servers further comprises a server baseboard management controller therein for collecting the temperature value of the server to update the first information.

11. The rack server system of claim 9, wherein the first information further comprises an Internet address which is allocated on the rack by the servers and a plurality of temperature sensors within the servers, and the temperature sensors transfer the temperature values to the server baseboard management controller of the servers.

12. The rack server system of claim 9, further comprising at least one fan control module coupled to the fan modules and the rack management module, wherein the rack management module reads the second information and transmits at least one control signal, and the fan control module adjusts the speed of the fan modules according to the control signal.

13. The rack server system of claim 9, wherein the rack management module is a rack baseboard management controller.

14. The rack server system of claim 9, further comprising a display unit for displaying the first information and the second information of the document management unit.

15. The rack server system of claim 9, wherein the number of the rack management modules is two and the rack management modules are redundant to each other.

16. The rack server system of claim 9, wherein the first information and the second information are corresponding to each other and the second information is adjusted according to the first information.
